(19) United States
(12) Patent Application Publication
(10) Pub. No.: US 2016/0050271 A1
(43) Pub. Date: Feb. 18, 2016

(54) COMMUNICATION APPARATUS, CONTENT CLIENT AND CONTENT SERVER

(71) Applicant: KABUSHIKI KAISHA TOSHIBA, Tokyo (JP)

(72) Inventors: Yuji TOHZAKA, Kawasaki (JP); Takafumi SAKAMOTO, Tokyo (JP); Yusuke DOI, Yokohama (JP); Michihiro FUKUSHIMA, Tokyo (JP)

(21) Appl. No.: 14/790,155

(22) Filed: Jul. 2, 2015

(30) Foreign Application Priority Data
Aug. 13, 2014 (JP) 2014-164958

(51) Int. Cl. H04L 29/08

(52) U.S. Cl. CPC H04L 67/1095

(57) ABSTRACT

According to an embodiment, a communication apparatus includes a timer, a synchronization processor and a signal generator. The timer updates a first timer value by counting up in synchronization with a clock signal. The synchronization processor executes a time synchronization process in order to synchronize the first timer value with a second timer value inside each of other communication apparatuses belonging to a common network. A signal generator generates a timing signal reporting arrival of a timing when content is to be controlled, based on the first timer value and content control information indicative of the timing when the content is to be controlled.

### CROSS-REFERENCE TO RELATED APPLICATIONS

This application is based upon and claims the benefit of priority from Japanese Patent Application No. 2014-164958, filed Aug. 13, 2014, the entire contents of which are incorporated herein by reference.

### FIELD

Embodiments relate to synchronous control of content at a plurality of locations.

### BACKGROUND

A technique is known which allows content to be synchronously reproduced at a plurality of display control terminals. In such a technique, each of the plurality of display control terminals sets a time for an internal clock based on time information transmitted by a synchronous server, and starts reproducing the content in synchronization with a reproduction start time set for the content.

However, the accuracy demanded for the synchronous reproduction of the content to be synchronously reproduced increases in line with the complexity of the content. For example, when a video with a frame rate of 120 fps is synchronously reproduced, given that the difference in time between display control terminals is approximately 8.3 msec or more, the display control terminals fail to simultaneously display the same frame.

### BRIEF DESCRIPTION OF THE DRAWINGS

FIG. 1 is a diagram illustrating a video synchronization display system according to a first embodiment;

FIG. 2 is a block diagram illustrating a hardware configuration of a video server in FIG. 1;

FIG. 3 is a block diagram depicting a modification of a hardware configuration of a server apparatus in FIG. 2;

FIG. 4 is a block diagram illustrating a functional configuration of the video server in FIG. 1;

FIG. 5 is a block diagram illustrating a hardware configuration of a video client in FIG. 1;

FIG. 6 is a block diagram illustrating a functional configuration of the video client in FIG. 1;

FIG. 7 is a block diagram depicting a modification of a functional configuration of the video client in FIG. 6;

FIG. 8 is a block diagram depicting a modification of a hardware configuration of a client apparatus in FIG. 5;

FIG. 9 is a sequence diagram illustrating operations of the video synchronization display system according to the first embodiment;

FIG. 10 is a diagram depicting a video synchronization display system according to a second embodiment;

FIG. 11 is a block diagram illustrating a hardware configuration of a video server in FIG. 10;

FIG. 12 is a block diagram illustrating a functional configuration of the video server in FIG. 10;

FIG. 13 is a sequence diagram illustrating operations of a video synchronization display system according to the second embodiment;

FIG. 14 is a diagram depicting a content synchronization output system according to a third embodiment;

FIG. 15 is a block diagram illustrating a hardware configuration of a content server in FIG. 14;

FIG. 16 is a block diagram illustrating a functional configuration of the content server in FIG. 14;

FIG. 17 is a block diagram illustrating a hardware configuration of a content client in FIG. 14;

FIG. 18 is a block diagram illustrating a functional configuration of the content client in FIG. 14; and

FIG. 19 is a diagram illustrating operations of a video client according to the first embodiment.

### DETAILED DESCRIPTION

Embodiments will be described below with reference to the drawings.

According to an embodiment, a communication apparatus includes a timer, a synchronization processor and a signal generator. The timer updates a first timer value by counting up in synchronization with a clock signal. The synchronization processor executes a time synchronization process in order to synchronize the first timer value with a second timer value inside each of other communication apparatuses belonging to a common network. A signal generator generates a timing signal reporting arrival of a timing when content is to be controlled, based on the first timer value and content control information indicative of the timing when the content is to be controlled.

Elements identical or similar to described elements are denoted by identical or similar reference numerals, and duplicate descriptions are basically omitted.

### First Embodiment

A video synchronization display system according to a first embodiment includes a video server and a plurality of video clients. The video server includes a server apparatus 100 and a communication apparatus 200. The video client includes a communication apparatus 300, a client apparatus 400, and a display apparatus 500.

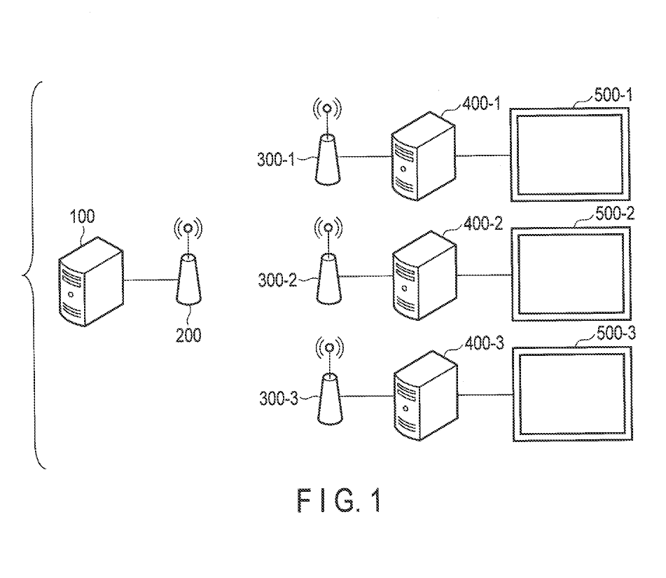

The video synchronization display system according to the present embodiment is illustrated in FIG. 1. The video synchronization display system in FIG. 1 includes a video server and three video clients. In the description below, when a plurality of elements are present which have a function common to an element denoted by reference numeral “XXX”, the elements are distinguished from one another by adding branch numbers to reference numeral “XXX”.

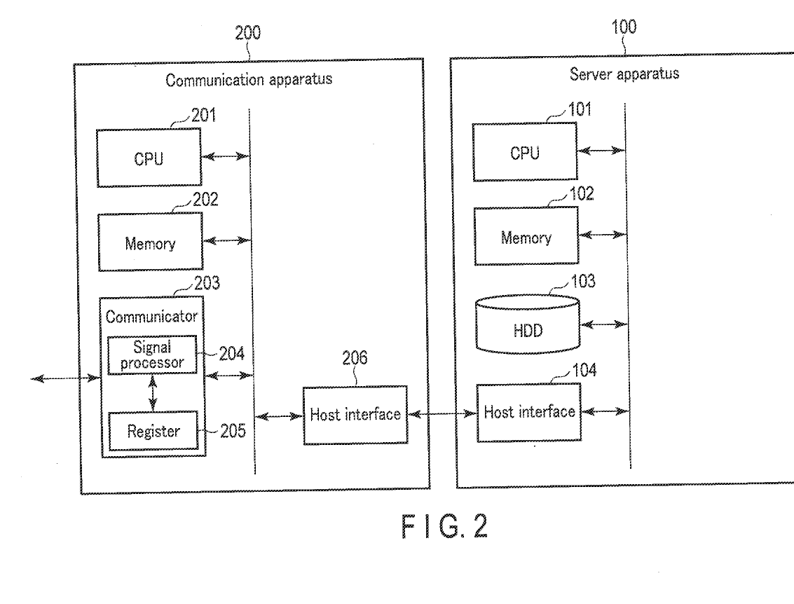

FIG. 2 depicts an example of hardware configurations of the server apparatus 100 and the communication apparatus 200.

The server apparatus 100 in FIG. 2 includes a CPU (Central Processing Unit) 101, a memory 102, an HDD (Hard Disk Drive) 103, and a host interface 104. The pieces of hardware included in the server apparatus 100 in FIG. 2 are connected together via a bus.

The CPU 101, for example, executes programs saved in the memory 102 to control the hardware included in the server apparatus 100. The CPU 101 may be replaced with various processors, for example, an MPU (Micro Processing Unit), an MeP (Media embedded Processor), a microcontroller, an FPGA (Field Programmable Gate Array), and a GPU (Graphics Processing Unit).

For example, programs executed by the CPU 101 and data used by the programs are temporarily saved in the memory 102. The memory 102 may be a volatile memory, for example, an SRAM (Static Random Access Memory) or a DRAM (Dynamic RAM), or a nonvolatile memory.

For example, video content to be distributed to the video clients is saved in the HDD 103. The HDD 103 may be replaced, for example, with an SSD (Solid State Drive) or with a flash memory connected to the bus via host interface not depicted in the drawings.

The host interface 104 transmits signals (signals carrying, for example, video content or content control information) between the server apparatus 100 and the communication apparatus 200.

The host interface 104 may be a general-purpose interface, for example, a USB (Universal Serial Bus), an SDIO (Secure Digital Input/Output), a UART (Universal Asynchronous Receiver Transmitter), an I2C (Inter Integrated Circuit), an SPI (Serial Peripheral Interface), or a PCIe (Peripheral Component Interconnect Express), or a dedicated interface.

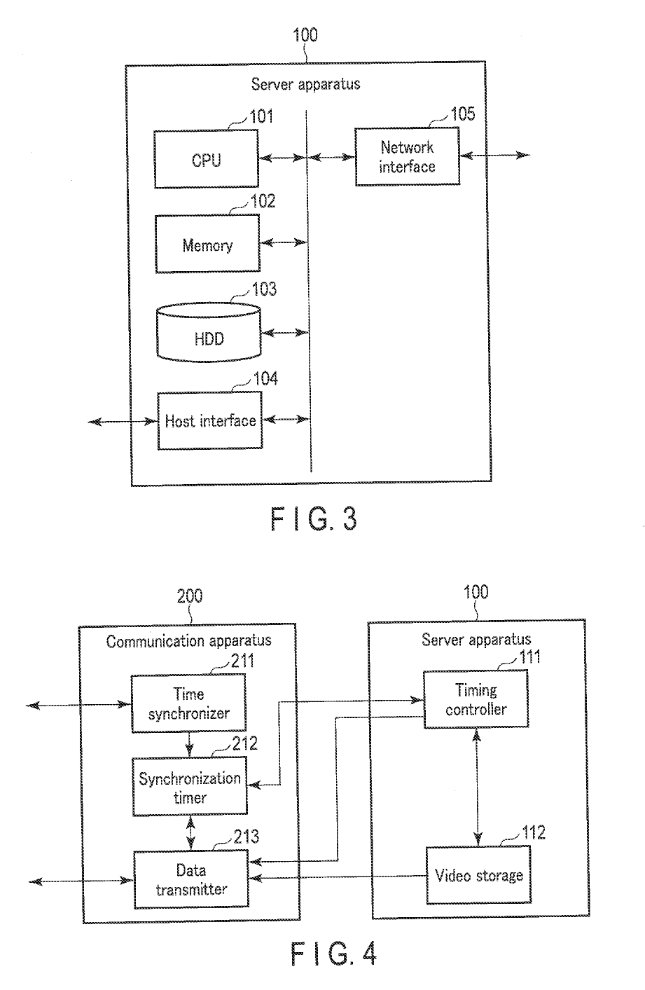

The server apparatus 100 may be modified as illustrated in FIG. 3. The server apparatus 100 in FIG. 3 is different from the server apparatus 100 in FIG. 2 in that the server apparatus 100 in FIG. 3 further comprises a network interface 105. The server apparatus 100 may be connected to the Internet via the network interface 105 to transmit, receive, or control video contents or time-synchronize with an NTP (Network Time Protocol) server. The network interface 105 may be incorporated in the communication apparatus 200, the communication apparatus 300, or the client apparatus 400.

The communication apparatus 200 in FIG. 2 includes a CPU 201, a memory 202, a communicator 203, and a host interface 206. The pieces of hardware included in the communication apparatus 200 are connected together via a bus.

The CPU 201, for example, executes programs saved in the memory 202 to control the hardware included in the communication apparatus 200. For example, the CPU 201 executes processing for an IP (Internet Protocol) layer, a TCP (Transmission Control Protocol) layer or a UDP (User Datagram Protocol) layer, or a further higher layer. Such processing may be executed via an OS (Operating System).

The CPU 201 may be replaced with various processors, for example, an MPU, an MeP, a microcontroller, a DSP (Digital Signal Processor), and an FPGA.

For example, programs executed by the CPU 201 and data used by the programs are temporarily saved in the memory 202. The memory 202 may be a volatile memory, for example, an SRAM or a DRAM, or a nonvolatile memory.

The communicator 203 performs data communication with the video client. Specifically, the communicator 203 executes a part or all of the processing for a PHY (Physical) layer or an MAC (Media Access Control) layer.

For example, the communicator 203 transmits a frame allowing establishment of connection with the communication apparatus 300 included in the video client. As described below, times referenced by the communication apparatus 200 and the communication apparatus 300 synchronize with each other through a connection process for the communication apparatus 200 and the communication apparatus 300. The communicator 203 transmits data frames in which, for example, video content or content control information is carried, to the communication apparatus 300. The communicator 203 includes a signal processor 204 and a register 205.

The signal processor 204 executes at least digital signal processing related to data transmission and reception. Moreover, the signal processor 204 may include an analog signal processing circuit, for example, a DAC (Digital-to-Analog Converter), an ADC (Analog-to-Digital Converter), an LNA (Low Noise Amplifier), or an antenna in order to execute analog signal processing related to data transmission and reception. A part or the entire analog signal processing circuit may be provided outside the communicator 203.

For example, data exchanged between the signal processor 204 and the CPU 201 is temporarily saved in the register 205. Moreover, a part of the register 205 may be used as a synchronization timer described below.

The host interface 206 transmits signals (signals carrying, for example, video content or content control information) between the communication apparatus 200 and the server apparatus 100. The host interface 206 may be a general-purpose interface, for example, a USB, an SDIO, a UART, an I2C, an SPI, or a PCIe, or a dedicated interface.

FIG. 4 depicts an example of a functional configuration of the server apparatus 100 and the communication apparatus 200.

The server apparatus 100 includes a timing controller 111 and a video storage 112.

The timing controller 111 determines a timing when predetermined control is performed on content. The timing controller 111 generates content control information explicitly or implicitly indicative of the determined timing, and outputs the content control information to a data transmitter 213. The content control information may be information explicitly or implicitly indicative of a reproduction start time for video content to be synchronously displayed.

The timing controller 111 may reference a timer value counted up by a synchronization timer 212 inside the communication apparatus 200 to determine the above-described timing based on the timer value. Specifically, the timing controller 111 may determine a particular absolute time later than the timer value to be the reproduction start time.

Furthermore, the timing controller 111 may determine a relative time needed to calculate the reproduction start time. In this case, a first technique and a second technique may be adopted; in the first technique, the video server calculates the reproduction start time, and in the second technique, each video client calculates the reproduction start time.

According to the first technique, the timing controller 111 outputs content control information indicative of a relative time to the data transmitter 213. The data transmitter 213 calculates the reproduction start time by adding the timer value in the synchronization timer 212 to the relative time indicated by the content control information. The data transmitter 213 complements the content control information with the calculated reproduction start time and transmits the information to the plurality of video clients.

According to the second technique, the data transmitter 213 transmits the content control information indicative of the relative time determined by the timing controller 111, to the plurality of video clients. Each of the video clients calculates the reproduction start time by adding the relative time indicated by the content control information to the timer value in the synchronization timer inside the video client. However, compared to the first technique, the second technique may involve a degraded synchronization accuracy due to, for example, a channel transmission delay or a reception process delay.

Video content to be distributed to the video client is saved in the video storage 112. The video content saved in the video storage 112 is read as needed and transferred to the data transmitter 213. The video storage 112 is not necessary given that the video content to be synchronously displayed is already saved in all the video clients. However, when there are a plurality of video contents that can be selected, identifier information that allows the video contents to be identified may be transmitted in order to uniquely identify the video content to be synchronously displayed.

The communication apparatus 200 includes a time synchronizer 211, a synchronization timer 212, and a data transmitter 213.

The time synchronizer 211 executes a predetermined time synchronization process when the video server and the plurality of video clients establish connections. The time synchronization process depends on a network architecture formed by the video server and the plurality of video clients.

The video server and the plurality of video clients may form a star network such as in an infrastructure mode in accordance with the IEEE 802.11 standard, which is also known as a wireless LAN standard or a Wi-Fi standard. The star network comprises a master (hereinafter referred to as an AP (Access Point)) corresponding to a hub and one or more slaves (STAs (Stations) connected to the AP. A wireless communication apparatus supporting the IEEE 802.11 standard uses a 64-bit timer as a count-up timer operating in units of microseconds. The count-up timer is hereinafter referred to as a TSF (Timing Synchronization Function) timer.

The AP transmits beacon frames at a period of approximately 100 msec. The beacon frame contains the timer value in the TSF timer inside the AP. The timer value is described by the AP immediately before transmission of the beacon frame. Each STA overwrites the timer value in the TSF timer inside the STA with the timer value described in the received beacon frame. As a result, the TSF timers inside the wireless communication apparatuses in the common network (hereinafter also referred to as a BSS (Basic Service Set) synchronize with one another. Such a framework of the IEEE 802.11 standard enables accurate time synchronization though hardware control. Specifically, a desired accuracy for a quartz oscillator in the IEEE 802.11 standard is 20 ppm, and the transmission period of the beacon frame is approximately 100 msec. Thus, the synchronization accuracy for the TSF timers inside the wireless communication apparatuses in the common network can be estimated to be under several of tens of μsec.

Alternatively, the video server and the plurality of video clients may form a peer-to-peer network such as in an ad-hoc mode in accordance with the IEEE 802.11 standard. In the ad-hoc mode, any wireless communication apparatuses can communicate directly with each other, and all the wireless communication apparatuses transmit and receive beacon frames. Each wireless communication apparatus overwrites the timer value in the internal TSF timer with the timer value described in the received beacon frame when the timer value described in the received beacon frame is greater than the timer value in the TSF timer. As a result, the TSF timers inside the wireless communication apparatuses in the common network synchronize with one another.

The network that can be formed by the video server and the plurality of video clients is not limited to the network specified in the IEEE 802.11 standard.

Given that the video server in FIG. 4 functions as a master (for example, an AP) corresponding to the hub in the star network, the time synchronizer 211 transmits, to slaves (that is, the plurality of video clients), timer control information allowing the timer value in the synchronization timer 212 inside the communication apparatus 200 to be communicated as a reference timer value. The timer control information may be a management frame, for example, a beacon frame.

On the other hand, given that the video server in FIG. 4 functions as a slave (for example, an STA) in the star network, the time synchronizer 211 receives the timer control information from the master (that is, one of the plurality of video clients or a master (which may be, for example, the normal AP) provided separately from the plurality of video clients). Then, the time synchronizer 211 overwrites the timer value in the synchronization timer 212 with the reference timer value indicated by the timer control information.

When the video server and the plurality of video clients form a star network, the video server is preferably allowed to function as a master in terms of the frequency usage efficiency for carrying, for example, video content or content control information. However, the video server may be allowed to function as a slave. In either case, the accuracy of time synchronization is equal.

When the video server and plurality of video clients in FIG. 4 form a peer-to-peer network, the time synchronizer 211 transmits timer control information to the plurality of video clients and also receives timer control information from the plurality of video clients. The time synchronizer 211 corrects the timer value in the synchronization timer 212 based on the reference timer value indicated by the received timer control information. For example, the time synchronizer 211 overwrites the timer value in the synchronization timer 212 with the reference timer value indicated by the received timer control information when the reference timer value is greater (or less) than the timer value in the synchronization timer 212.

The synchronization timer 212 updates the timer value by counting up in accordance with a clock signal generated by a clock element, for example, a quartz oscillator. The timer value in the synchronization timer 212 is read by the time synchronizer 211 as needed. Moreover, the timer value in the synchronization timer 212 may be corrected by the time synchronizer 211 during the above-described time synchronization process.

As described above, the synchronization timer 212 may be implemented using a part of the register 205. Such an implementation allows hardware control to be performed on the synchronization timer 212, enabling accurate time synchronization. However, software control may be performed on the synchronization timer 212. The synchronization timer 212 may be implemented, for example, by using a part of the memory 202.

The data transmitter 213 accesses a channel based on the timer value in the synchronization timer 212 to transmit various data to the plurality of video clients. For example, the data transmitter 213 may transmit video content, content control information, and the like.

Specifically, the data transmitter 213 may simultaneously transmit video content and content control information to the plurality of video clients by means of broadcasting or transmit video content and content control information individually to the plurality of video clients by means of unicasting. Furthermore, the data transmitter 213 may transmit content control information to the plurality of video clients along with video content or transmit content control information to the plurality of video clients separately from the video content. For example, in a streaming service, the data transmitter 213 may transmit content control information to the plurality of video clients during distribution of video content. When the content control information is transmitted separately from the video content, the content control information may include information allowing the corresponding video content to be identified.

A plurality of video contents displayed by the plurality of video clients may be intentionally varied or a time difference may be intentionally made in a reproduction start time among the plurality of video clients. For example, to produce an interactive effect among the plurality of video clients, different videos may be displayed, a plurality of videos resulting from division of one original image at in-screen positions may be displayed, or a plurality of videos resulting from temporal division of one original image may be displayed.

Hence, the data transmitter 213 may transmit different video contents to the plurality of video clients or transmit different pieces of content control information to the plurality of video clients. To simultaneously transmit different video contents or different pieces of content control information to the plurality of video clients, the data transmitter 213 may utilize various multiple access schemes. Specifically, the data transmitter 213 may utilize, for example, FDMA (Frequency Division Multiple Access), OFDMA (Orthogonal FDMA), CDMA (Code Division Multiple Access), SDMA (Space Division Multiple Access), or multiuser MIMO (Multiple Input Multiple Output).

Moreover, when the content control information received from the timing controller 111 is indicative of a relative time, the data transmitter 213 may calculate, for example, the reference timer value, by adding the timer value in the synchronization timer 212 to the relative time. Then, the data transmitter 213 complements the content control information with the calculated reproduction start time and transmits the information to the plurality of video clients.

The time synchronizer 211 and the data transmitter 213 are expressed as separate elements in FIG. 4 but may both be implemented using the communicator 203.

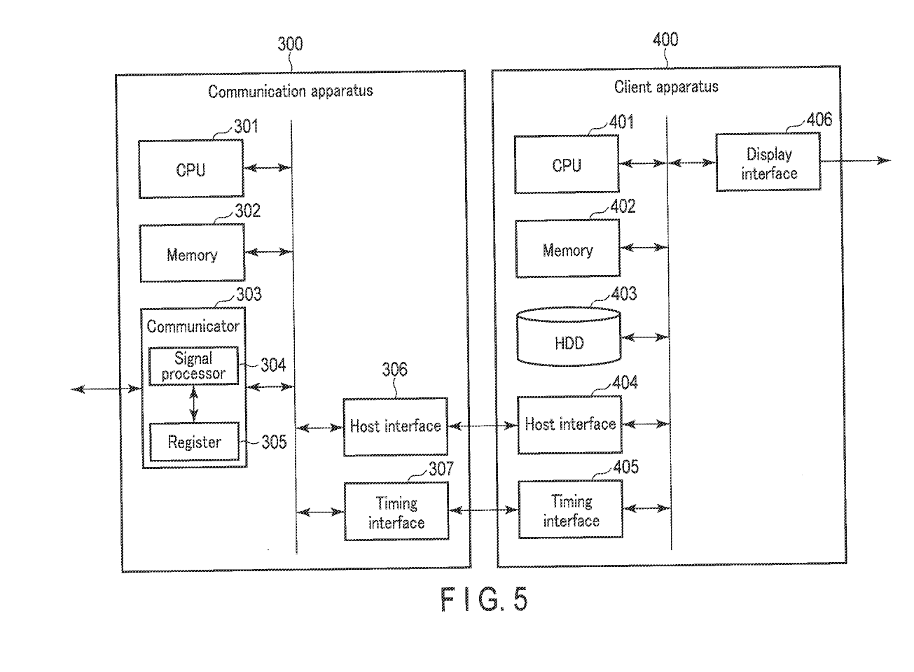

FIG. 5 depicts an example of a hardware configuration of the communication apparatus 300 and the client apparatus 400.

The communication apparatus 300 in FIG. 5 includes a CPU 301, a memory 302, a communicator 303, a host interface 306, and a timing interface 307. The pieces of hardware included in the communication apparatus 300 in FIG. 5 are connected together via a bus.

The CPU 301, for example, executes programs saved in the memory 302 to control the hardware included in the communication apparatus 300. For example, the CPU 301 executes processing for the IP layer, the TCP layer or the UDP layer, or a further higher layer. Such processing may be executed via the OS. The CPU 301 may be replaced with various processors, for example, an MPU, an MeP, a microcontroller, and an FPGA.

For example, programs executed by the CPU 301 and data used by the programs are temporarily saved in the memory 302. The memory 302 may be a volatile memory, for example, an SRAM or a DRAM, or a nonvolatile memory.

The communicator 303 performs data communication with the video server. Specifically, the communicator 303 executes a part or all of the processing for the PHY layer or the MAC layer. For example, the communicator 303 transmits a frame allowing establishment of connection with the communication apparatus 300 included in the video server. Times referenced by the communication apparatus 200 and the communication apparatus 300 synchronize with each other through a connection process for the communication apparatus 200 and the communication apparatus 300. The communicator 303 receives data frames in which, for example, video content or content control information is carried, from the communication apparatus 200. The communicator 303 includes a signal processor 304 and a register 305.

The signal processor 304 executes at least digital signal processing related to data transmission and reception. Moreover, the signal processor 304 may include an analog signal processing circuit, for example, a DAC, an ADC, an LNA, or an antenna in order to execute analog signal processing related to data transmission and reception. A part or all of the analog signal processing circuit may be provided outside the communicator 303.

For example, data exchanged between the signal processor 304 and the CPU 301 is temporarily saved in the register 305. Moreover, a part of the register 305 may be used as the synchronization timer.

The host interface 306 transmits signals other than those which are related to the timing (signals carrying, for example, video content) between the communication apparatus 300 and the server apparatus 100. The host interface 306 may be a general-purpose interface, for example, a USB, an SDIO, a UART, an I2C, an SPI, or a PCIe, or a dedicated interface.

The timing interface 307 outputs signals related to the timing to the client apparatus 400. The signals related to the timing include, for example, a first timing signal described below, a signal carrying content control information, and a signal carrying the timer value from the synchronization timer. The timing interface 307 may be a digital general-purpose interface, for example, a USB, an SDIO, a UART, an I2C, an SPI, or a PCIe, or an analog general-purpose interface, for example, a PIO (Parallel Input/Output) or a GPIO (General Purpose Input/Output). A transmission delay in the signal related to the timing affects the synchronization accuracy for displayed videos. Thus, the timing interface 307 preferably has a short transmission delay and an insignificant fluctuation in transmission delay.

The client apparatus 400 in FIG. 5 includes a CPU 401, a memory 402, an HDD 403, a host interface 404, a timing interface 405, and a display interface 406. The pieces of hardware included in the client apparatus 400 in FIG. 5 are connected together via a bus.

The CPU 401, for example, executes programs saved in the memory 402 to control the hardware included in the client apparatus 400. The CPU 401 may be replaced with various processors, for example, an MPU, an MeP, a microcontroller, an FPGA, and a GPU.

For example, programs executed by the CPU 401 and data used by the programs are temporarily saved in the memory 402. The memory 402 may be a volatile memory, for example, an SRAM or a DRAM, or a nonvolatile memory.

For example, video content distributed by the video server is saved in the HDD 403. The HDD 403 may be replaced with, for example, an SSD or with a flash memory connected to the bus via a host interface not depicted in the drawings.

The host interface 404 transmits signals other than those which are related to the timing (signals carrying, for example, video content) between the client apparatus 400 and the communication apparatus 300. The host interface 404 may be a general-purpose interface, for example, a USB, an SDIO, a UART, an I2C, an SPI, or a PCIe, or a dedicated interface.

The timing interface 405 receives signals related to the timing from the communication apparatus 300. The timing interface 405 may be a digital general-purpose interface, for example, a USB, an SDIO, a UART, an I2C, an SPI, or a PCIe, or an analog general-purpose interface, for example, a PIO or a GPIO. A transmission delay in the signal related to the timing affects the synchronization accuracy for displayed videos. Thus, the timing interface 405 preferably has a short transmission delay and an insignificant fluctuation in transmission delay.

The display interface 406 transmits signals (for example, a video signal) between the client apparatus 400 and the display apparatus 500.

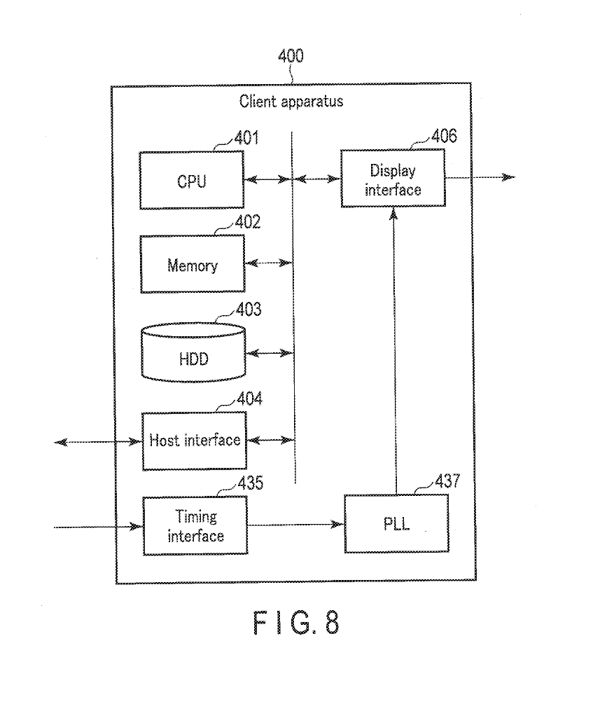

The client apparatus 400 in FIG. 5 may be modified as illustrated in FIG. 8. The client apparatus 400 in FIG. 8 is different from the client apparatus 400 in FIG. 5 in that the client apparatus 400 in FIG. 8 comprises a timing interface 435 instead of the timing interface 405 and further comprises PLL (Phase Locked Loop) 437.

The timing interface 435 is different from the timing interface 405 in that no bus is used for connection of the timing interface 435 and in that the timing interface 435 is connected directly to a PLL 437.

The PLL 437 receives the first timing signal, which is periodic, from the communication apparatus 300 via the timing interface 435. The PLL 437 generates a second timing signal with a desired period with reference to the period of the first timing signal, and outputs the second timing signal to the display interface 406. The display interface 406 outputs a reproduction video signal to the display apparatus 500 in accordance with the second timing signal. The desired period may be, for example, the interval between frames in video content or the interval between I (Intra) picture frames in a GOP (Group Of Pictures) in accordance with the MPEG (Moving Picture Experts Group) technique. The desired period may be determined based on characteristic information such as a frame rate included in header information on the video content. Moreover, the desired period may be different from or identical to the period of the first timing signal. Even when the desired period is identical to the period of the first timing signal, the PLL 437 acts to enable a reduction in fluctuation in period.

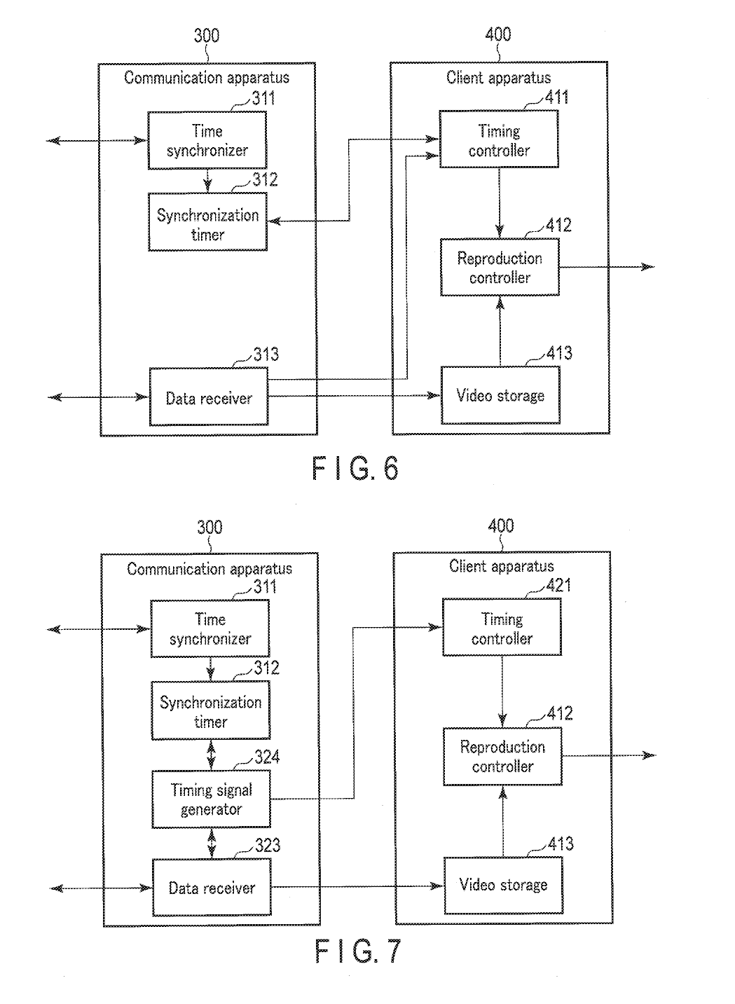

FIG. 6 depicts an example of a functional configuration of the communication apparatus 300 and the client apparatus 400.

The communication apparatus 300 includes a time synchronizer 311, a synchronization timer 312, and a data receiver 313.

The time synchronizer 311 executes a predetermined time synchronization process when the video server and the plurality of video clients establish connections. The time synchronization process depends on a network structure formed by the video server and the plurality of video clients.

For example, given that the video client in FIG. 6 functions as a master (for example, an AP) corresponding to the hub in the star network, the time synchronizer 311 transmits the above-described timer control information to slaves (that is, the video server and the other video clients).

On the other hand, given that the video client in FIG. 6 functions as a slave (for example, an STA) in the star network, the time synchronizer 311 receives the timer control information from the master (that is, the video server or one of the other video clients, or a master (which may be, for example, the normal AP) provided in order to form the star network). Then, the time synchronizer 311 overwrites the timer value in the synchronization timer 312 with the reference timer value indicated by the timer control information.

When the video server and plurality of video clients form the above-described peer-to-peer network, the time synchronizer 311 transmits timer control information to the video server and the other video clients and also receives timer control information from the video server and the other video clients. The time synchronizer 311 corrects the timer value in the synchronization timer 312 based on the reference timer value indicated by the received timer control information. For example, the time synchronizer 311 overwrites the timer value in the synchronization timer 312 with the reference timer value indicated by the received timer control information when the reference timer value is greater (or less) than the timer value in the synchronization timer 212.

The synchronization timer 312 updates the timer value by counting up in accordance with a clock signal generated by a clock element, for example, a quartz oscillator. The timer value in the synchronization timer 312 is read by the time synchronizer 311 as needed. Moreover, the timer value in the synchronization timer 312 may be corrected by the time synchronizer 311 during the above-described time synchronization process.

As described above, the synchronization timer 312 may be implemented using a part of the register 305. Such an implementation allows hardware control to be performed on the synchronization timer 312, enabling accurate time synchronization. However, software control may be performed on the synchronization timer 312. The synchronization timer 312 may be implemented, for example, by using a part of the memory 302.

The data receiver 313 accesses a channel based on the timer value in the synchronization timer 312 to receive various data from the video server. For example, the data receiver 313 may receive video content, content control information, and the like. The data receiver 313 outputs video content to the client apparatus 400 via the host interface 306, and outputs content control information to the client apparatus 400 via the timing interface 307.

Moreover, when the received content control information is indicative of a relative time instead of an absolute time, the data receiver 313 may calculate the absolute time, for example, the reproduction start time by adding the timer value in the synchronization timer 312 to the relative time. Then, the data receiver 313 complements the content control information with the calculated absolute time and transmits the information to the client apparatus 400 via the timing interface 307.

The time synchronizer 311 and the data receiver 313 are expressed as separate elements in FIG. 6 but may both be implemented using the communicator 303.

The client apparatus 400 includes a timing controller 411, a reproduction controller 412, and a video storage 413.

The timing controller 411 receives a signal carrying the current timer value from the synchronization timer 312, and also receives a signal carrying content control information from the data receiver 313. Based on the current timer value and the content control information, the timing controller 411 generates a timing signal reporting arrival of a control timing (for example, the reproduction start time) for the video content stored in the video storage 413. The timing controller 411 outputs the timing signal to the reproduction controller 412.

The reproduction controller 412 receives the timing signal from the timing controller 411 and reads the video content from the video storage 413. The reproduction controller 412 performs control such as reproduction and stoppage of the video content on a timely basis in accordance with the timing signal. The reproduction controller 412 may utilize a timing signal based on a reproduction end time as well as the reproduction start time. Such a timing signal is effective in view of fail safety. Furthermore, the reproduction controller 412 may utilize a periodic timing signal in order to stably maintain synchronization for a long period.

The video storage 413 receives a signal carrying video content from the data receiver 313 via the host interface 404. The received video content is stored in the video storage 413. The video content stored in the video storage 413 may be read by the reproduction controller 412 as needed.

The video client in FIG. 6 may be modified as depicted in FIG. 7.

The communication apparatus 300 in FIG. 7 is different from the communication apparatus 300 in FIG. 6 in that the communication apparatus 300 in FIG. 7 comprises a data receiver 323 instead of the data receiver 313 and further comprises a timing signal generator 324.

The data receiver 323 is different from the data receiver 313 in that the content control information is output to the timing signal generator 324 instead of the client apparatus 400.

The timing signal generator 324 receives a signal carrying the current timer value from the synchronization timer 312, and receives a signal carrying the content control information from the data receiver 323. Based on the current timer value and the content control information, the timing signal generator 324 generates a first timing signal reporting arrival of a control timing (for example, the reproduction start time) for the video content stored in the video storage 413. The timing signal generator 324 outputs the first timing signal to the client apparatus 400 via the timing interface 307.

A processor functioning as the timing signal generator 324 (the processor may be, for example, the CPU 301 or a processor not depicted in the drawings) may be, for example, the same as a processor functioning as a part of the time synchronizer 311 and the data receiver 323. In this case, for example, a communication process for the time synchronizer 311 or the data receiver 323 may cause a delay in a timing signal generation process for the timing signal generator 324. Thus, the processor as the timing signal generator 324 may evaluate a processing load on the processor and schedule an execution timing for the timing signal generation process so that the process is executed earlier in accordance with the magnitude of the processing load. For example, when the processing load is equal to or higher than a threshold, the processor as the timing signal generator 324 may schedule the execution timing for the timing signal generation process so that the process is executed a predetermined time earlier than in the normal case (where the processing load is lower than the threshold). Such scheduling allows compensation for a delay in the timing signal generation process caused by the processing load. An appropriate value for the predetermined time depends on factors such as the performance of the processor serving as the timing signal generator 324 and is thus desirably adjusted through experiments.

The client apparatus 400 in FIG. 7 is different from the client apparatus 400 in FIG. 6 in that the client apparatus 400 in FIG. 7 comprises a timing controller 421 instead of the timing controller 411.

The timing controller 421 receives the first timing signal from the communication apparatus 300 via the timing interface 405 or the timing interface 435. For example, given that the first timing signal is periodic, the timing controller 421 may generate a second timing signal with the above-described desired period with reference to the period of the first timing signal. The timing controller 421 outputs the second timing signal to the reproduction controller 412. Moreover, the desired period may be different from or identical to the period of the first timing signal. Even when the desired period is identical to the period of the first timing signal, the timing controller 421 acts to enable a reduction in fluctuation in period. Alternatively, the timing controller 421 may generate a second timing signal by reducing or increasing the voltage of the first timing signal so that the voltage of the second timing signal falls within the range of the input voltage to the reproduction controller 412.

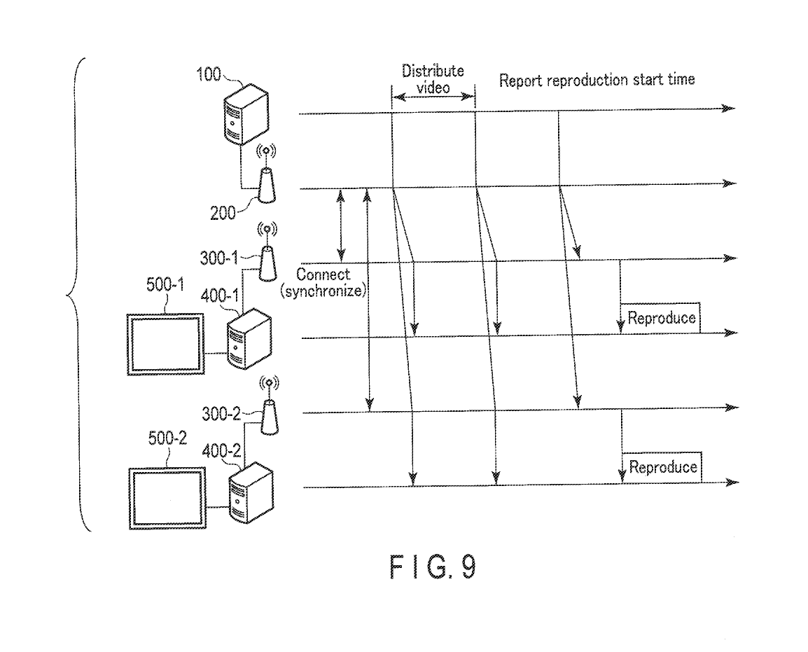

The video synchronization display system according to the present embodiment can operate as illustrated in FIG. 9. In the example in FIG. 9, a communication apparatus 300-1 and a communication apparatus 300-2 connect to the communication apparatus 200, and the synchronization timers in the communication apparatuses 300-1 and 300-2 accurately synchronize with each other. Then, the content server distributes video content to the two content clients and notifies the content clients of the reproduction start time (content control information). A client apparatus 400-1 and a client apparatus 400-2 can substantially simultaneously display the video content on a display apparatus 500-1 and a display apparatus 500-2 in accordance with a timing signal generated based on the reproduction start time and the timer values in the synchronization timers inside the communication apparatus 300-1 and the communication apparatus 300-2.

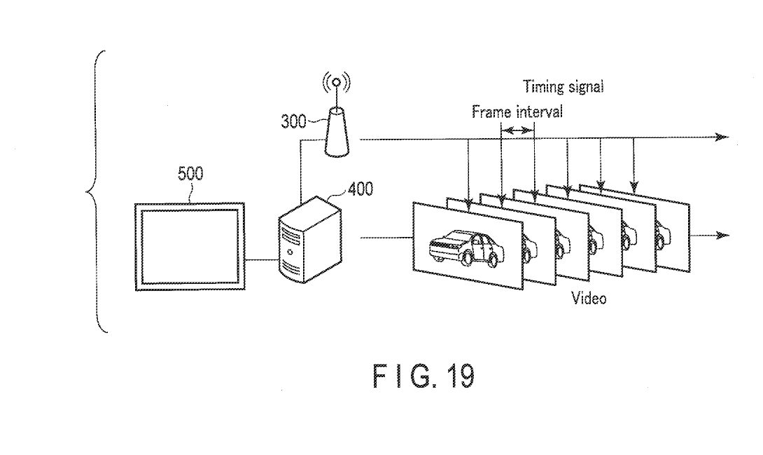

The video client according to the present embodiment may operate as illustrated in FIG. 19. In the example in FIG. 19, a timing signal with a period equal to the frame interval is used, and thus, the plurality of video clients can synchronously display video content at a frame level.

As described above, the video synchronization display system according to the first embodiment establishes connections among the communication apparatuses included in the video server and the plurality of video clients to accurately synchronize the timers inside the communication apparatuses with one another. The video synchronization display system then performs various types of control on video content based on the timer values in the timers. Thus, the video synchronization display system allows the plurality of video clients to accurately synchronously display the video content.

### Second Embodiment

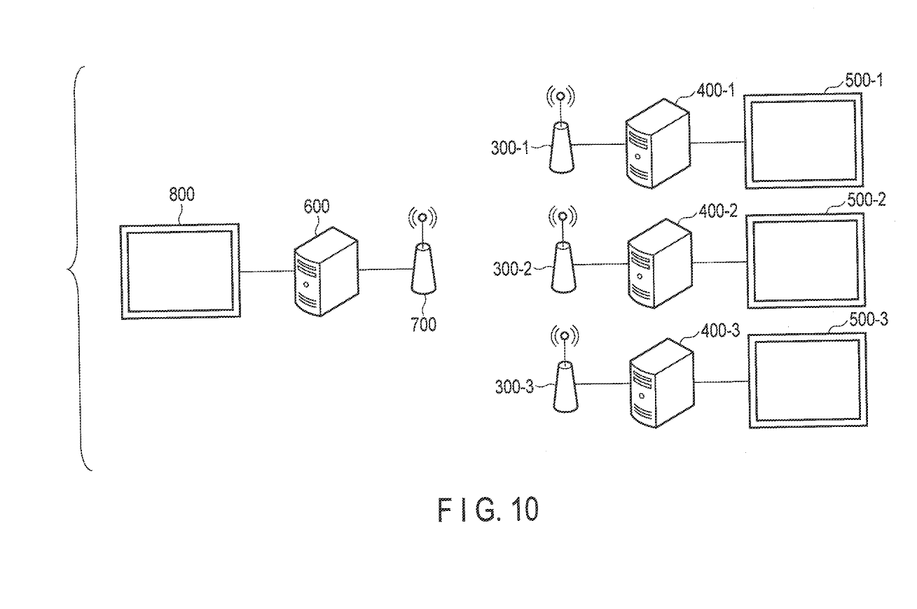

A video synchronization display system according to a second embodiment is different from the video synchronization display system according to the first embodiment in that a video server also displays video content. Specifically, the video synchronization display system includes the video server and one or more video clients. The video server includes a server apparatus 600, a communication apparatus 700, and a display apparatus 800. The video client includes a communication apparatus 300, a client apparatus 400, and a display apparatus 500. The video synchronization display system according to the present embodiment is illustrated in FIG. 10. The video synchronization display system in FIG. 10 includes a video server and three video clients.

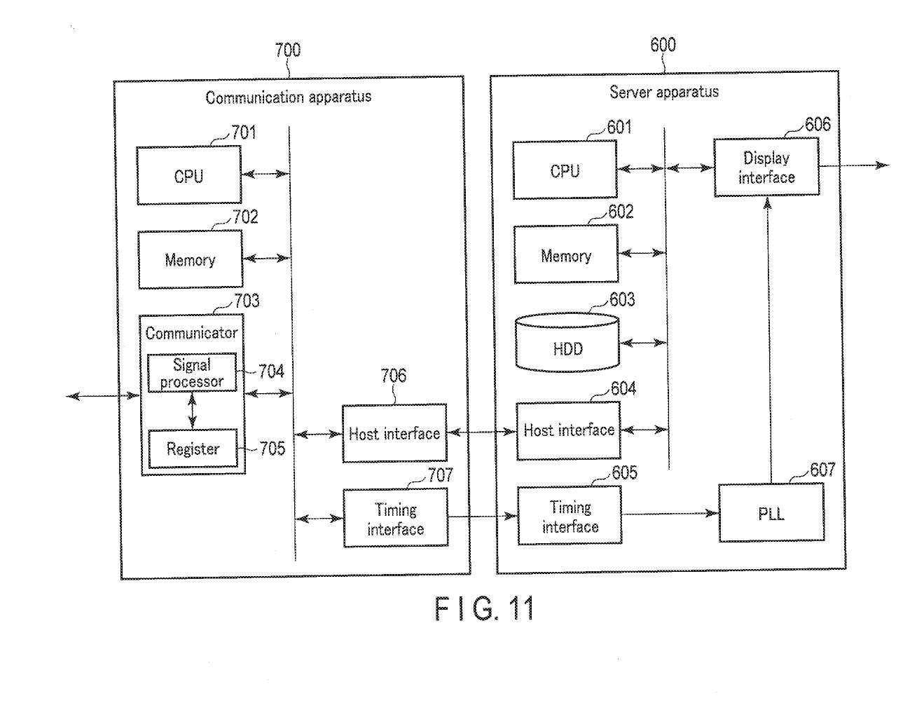

FIG. 11 depicts an example of hardware configurations of the server apparatus 600 and the communication apparatus 700.

The server apparatus 600 in FIG. 11 includes a CPU 601, a memory 602, an HDD 603, a host interface 604, a timing interface 605, a display interface 606, and a PLL 607. The CPU 601, the memory 602, the HDD 603, the host interface 604, and the display interface 606 are connected together via a bus. The server apparatus 600 in FIG. 11 has a hardware configuration similar to the hardware configuration of the client apparatus 400 in FIG. 8, but may have a hardware configuration similar to the hardware configuration of the client apparatus 400 in FIG. 5 instead of the hardware configuration in FIG. 8.

The CPU 601, for example, executes programs saved in the memory 602 to control the hardware included in the server apparatus 600. The CPU 601 may be replaced with various processors, for example, an MPU, an MeP, a microcontroller, an FPGA, and a GPU.

For example, programs executed by the CPU 601 and data used by the programs are temporarily saved in the memory 602. The memory 602 may be a volatile memory, for example, an SRAM or a DRAM, or a nonvolatile memory.

For example, video content to be distributed to the video clients is saved in the HDD 603. The video content may also be displayed by the display apparatus 800. The HDD 603 may be replaced, for example, with an SSD or with a flash memory connected to the bus via a host interface not depicted in the drawings.

The host interface 604 transmits signals other than those which are related to the timing (signals carrying, for example, video content) between the server apparatus 600 and the communication apparatus 700. The host interface 604 may be a general-purpose interface, for example, a USB, an SDIO, a UART, an I2C, an SPI, or a PCIe, or a dedicated interface.

The timing interface 605 receives a periodic first timing signal from the communication apparatus 700 and outputs the first timing signal to the PLL 607. The timing interface 605 may be a general-purpose interface, for example, a USB, an SDIO, a UART, an I2C, an SPI, or an analog general-purpose interface, for example, a PIO or a GPIO. A transmission delay in the first timing signal affects the synchronization accuracy for displayed videos. Thus, the timing interface 605 preferably has a short transmission delay and an insignificant fluctuation in transmission delay.

The display interface 606 transmits signals (for example, video signals) between the server apparatus 600 and the display apparatus 800.

The PLL 607 receives the periodic first timing signal from the communication apparatus 700 via the timing interface 605. The PLL 607 generates a second timing signal with a desired period with reference to the period of the first timing signal, and outputs the second timing signal to the display interface 606. The display interface 606 outputs a reproduction video signal to the display apparatus 800 in accordance with the second timing signal. The desired period may be, for example, the interval between frames in video content or the interval between I picture frames in a GOP in accordance with the MPEG technique. The desired period may be determined based on characteristic information such as a frame rate included in header information on the video content. Moreover, the desired period may be different from or identical to the period of the first timing signal. Even when the desired period is identical to the period of the first timing signal, the PLL 607 acts to enable a reduction in fluctuation in period.

The communication apparatus 700 in FIG. 11 includes a CPU 701, a memory 702, a communicator 703, a host interface 706, and a timing interface 707. The pieces of hardware included in the communication apparatus 700 in FIG. 11 are connected together via a bus.

The CPU 701, for example, executes programs saved in the memory 702 to control the hardware included in the communication apparatus 700. For example, the CPU 701 executes processing for the IP layer, the TCP layer or the UDP layer, or a further higher layer. Such processing may be executed via an OS. The CPU 701 may be replaced with various processors, for example, an MPU, an MeP, a microcontroller, a DSP, and an FPGA.

For example, programs executed by the CPU 701 and data used by the programs are temporarily saved in the memory 702. The memory 702 may be a volatile memory, for example, an SRAM or a DRAM, or a nonvolatile memory.

The communicator 703 performs data communication with the video client. Specifically, the communicator 703 executes a part or all of the processing for the PHY layer or the MAC layer. For example, the communicator 703 transmits a frame allowing establishment of connection with the communication apparatus 300 included in the video client. Times referenced by the communication apparatus 700 and the communication apparatus 300 synchronize with each other through a connection process for the communication apparatus 700 and the communication apparatus 300. The communicator 703 transmits data frames in which, for example, video content or content control information is carried, to the communication apparatus 300. The communicator 703 includes a signal processor 704 and a register 705.

The signal processor 704 executes at least digital signal processing related to data transmission and reception. Moreover, the signal processor 704 may include an analog signal processing circuit, for example, a DAC, an ADC, an LNA, or an antenna in order to execute analog signal processing related to data transmission and reception. A part or the entire analog signal processing circuit may be provided outside the communicator 703.

For example, data exchanged between the signal processor 704 and the CPU 701 is temporarily saved in the register 705. Moreover, a part of the register 705 may be used as a synchronization timer.

The host interface 706 transmits signals other than those which are related to the timing (signals carrying, for example, video content) between the communication apparatus 700 and the server apparatus 600. The host interface 706 may be a general-purpose interface, for example, a USB, an SDIO, a UART, an I2C, an SPI, or a PCIe, or a dedicated interface.

The timing interface 707 outputs the first timing signal to the server apparatus 600. The timing interface 707 may be a digital general-purpose interface, for example, a USB, an SDIO, a UART, an I2C, an SPI, or a PCIe, or an analog dedicated interface such as a PIO or a GPIO. A transmission delay in the first timing signal affects the synchronization accuracy for displayed videos. Thus, the timing interface 707 preferably has a short transmission delay and an insignificant fluctuation in transmission delay.

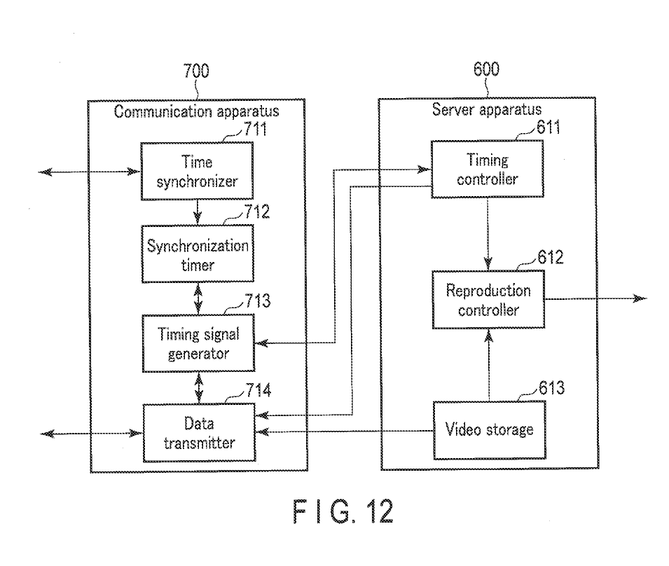

FIG. 12 depicts an example of a functional configuration of the server apparatus 600 and the communication apparatus 700.

The server apparatus 600 includes a timing controller 611, a reproduction controller 612, and a video storage 613.

The timing controller 611 determines a timing when predetermined control is performed on content. The timing controller 611 generates content control information explicitly or implicitly indicative of the determined timing, and outputs the content control information to a timing signal generator 713 and a data transmitter 714.

The timing controller 611 may reference a timer value in a synchronization timer 712 inside the communication apparatus 700 to determine the above-described timing based on the timer value. Specifically, the timing controller 611 may determine a particular absolute time later than the timer value to be the reproduction start time.

Furthermore, the timing controller 611 may determine a relative time needed to calculate the reproduction start time. In this case, the timing controller 611 outputs content control information indicative of a relative time to the data transmitter 714. The data transmitter 714 calculates the reproduction start time by adding the timer value in the synchronization timer 712 to the relative time indicated by the content control information. The data transmitter 714 complements the content control information with the calculated reproduction start time and transmits the information to the one or more video clients and to the timing signal generator 713.

Moreover, the timing controller 611 receives the first timing signal from the communication apparatus 700 via the timing interface 605. For example, given that the first timing signal is periodic, the timing controller 611 may generate a second timing signal with the above-described desired period with reference to the period of the first timing signal. The timing controller 611 outputs the second timing signal to the reproduction controller 612. Moreover, the desired period may be different from or identical to the period of the first timing signal. Even when the desired period is identical to the period of the first timing signal, the timing controller 611 acts to enable a reduction in fluctuation in period. Alternatively, the timing controller 611 may generate a second timing signal by reducing or increasing the voltage of the first timing signal so that the voltage of the second timing signal falls within the range of the input voltage to the reproduction controller 612.

The reproduction controller 612 receives the second timing signal from the timing controller 611 and reads the video content from the video storage 613. The reproduction controller 612 performs control such as reproduction and stoppage of the video content on a timely basis in accordance with the second timing signal. The reproduction controller 612 may utilize a timing signal based on a reproduction end time as well as the reproduction start time. Such a timing signal is effective in view of fail safety. Furthermore, the reproduction controller 612 may utilize a periodic timing signal in order to stably maintain synchronization for a long period.

Video content to be distributed to the video client is saved in the video storage 613. The video content saved in the video storage 613 is read as needed and transferred to the data transmitter 714. Moreover, the video content is read by the reproduction controller 612 as needed.

The communication apparatus 700 includes a time synchronizer 711, a synchronization timer 712, a timing signal generator 713, and a data transmitter 714.

The time synchronizer 711 executes a predetermined time synchronization process when the video server and the one or more video clients establish connections. The time synchronization process depends on a network architecture formed by the video server and the one or more video clients.

Given that the video server in FIG. 12 functions as a master (for example, an AP) corresponding to the hub in the star network, the time synchronizer 711 transmits the above-described timer control information to slaves (that is, the one or more video clients).

On the other hand, given that the video server in FIG. 12 functions as a slave (for example, an STA) in the star network, the time synchronizer 711 receives the timer control information from the master (that is, one of the one or more video clients or a master (which may be, for example, the normal AP)) provided in order to form the star network). Then, the time synchronizer 711 overwrites the timer value in the synchronization timer 712 with a reference timer value indicated by the timer control information.

When the video server and the one or more video clients form a star network, the video server is preferably allowed to function as a master in terms of the frequency usage efficiency for carrying, for example, video content or content control information. However, the video server may be allowed to function as a slave. In either case, the accuracy of time synchronization is equal.

When the video server and one or more video clients in FIG. 12 form a peer-to-peer network, the time synchronizer 711 transmits timer control information to the one or more video clients and also receives timer control information from the one or more video clients. The time synchronizer 711 corrects the timer value in the synchronization timer 712 based on the reference timer value indicated by the received timer control information. For example, the time synchronizer 711 overwrites the timer value in the synchronization timer 712 with the reference timer value indicated by the received timer control information when the reference timer value is greater (or less) than the timer value in the synchronization timer 712.

The synchronization timer 712 updates the timer value by counting up in accordance with a clock signal generated by a clock element, for example, a quartz oscillator. The timer value in the synchronization timer 712 is read by the time synchronizer 711 as needed. Moreover, the timer value in the synchronization timer 712 may be corrected by the time synchronizer 711 during the above-described time synchronization process.

As described above, the synchronization timer 712 may be implemented using a part of the register 705. Such an implementation allows hardware control to be performed on the synchronization timer 712, enabling accurate time synchronization. However, software control may be performed on the synchronization timer 712. The synchronization timer 712 may be implemented, for example, by using a part of the memory 702.

The timing signal generator 713 receives a signal carrying the current timer value from the synchronization timer 712, and receives a signal carrying the content control information from the timing controller 611 or the data transmitter 714. Based on the current timer value and the content control information, the timing signal generator 713 generates a first timing signal reporting arrival of a control timing (for example, the reproduction start time) for the video content stored in the video storage 613. The timing signal generator 713 outputs the first timing signal to the server apparatus 600 via the timing interface 707.

A processor functioning as the timing signal generator 713 (the processor may be, for example, the CPU 701 or a processor not depicted in the drawings) may be, for example, the same as a processor functioning as a part of the time synchronizer 711 and the data transmitter 714. In this case, for example, a communication process for the time synchronizer 711 or the data transmitter 714 may cause a delay in a timing signal generation process for the timing signal generator 714. Thus, the processor as the timing signal generator 713 may evaluate a processing load on the processor and schedule an execution timing for the timing signal generation process so that the process is executed earlier in accordance with the magnitude of the processing load. For example, when the processing load is equal to or higher than a threshold, the processor as the timing signal generator 713 may schedule the execution timing for the timing signal generation process so that the process is executed a predetermined time earlier than in the normal case (where the processing load is lower than the threshold). Such scheduling allows compensation for a delay in the timing signal generation process caused by the processing load. An appropriate value for the predetermined time depends on factors such as the performance of the processor serving as the timing signal generator 713 and is thus desirably adjusted through experiments.

The data transmitter 714 accesses a channel based on the timer value in the synchronization timer 712 to transmit various data to the one or more video clients. For example, the data transmitter 714 may transmit video content, content control information, and the like.

Specifically, the data transmitter 714 may simultaneously transmit video content and content control information to the one or more video clients by means of broadcasting or transmit video content and content control information individually to the one or more video clients by means of unicasting. Furthermore, the data transmitter 714 may transmit content control information to the one or more of video clients along with video content or transmit content control information to the one or more video clients separately from the video content. For example, in a streaming service, the data transmitter 714 may transmit content control information to the one or more video clients during distribution of video content. When the content control information is transmitted separately from the video content, the content control information may include information allowing the corresponding video content to be identified.

A plurality of video contents displayed by the one or more video clients may be intentionally varied or a time difference may be intentionally made in a reproduction start time among the one or more video clients. For example, to produce an interactive effect among the plurality of video clients, different videos may be displayed, a plurality of videos resulting from division of one original image at in-screen positions may be displayed, or a plurality of videos resulting from temporal division of one original image may be displayed.

Hence, the data transmitter 714 may transmit different video contents to the one or more video clients or transmit different pieces of content control information to the one or more video clients. To simultaneously transmit different video contents or different pieces of content control information to the one or more video clients, the data transmitter 714 may utilize various multiple access schemes. Specifically, the data transmitter 714 may utilize, for example, FDMA, OFDMA, CDMA, SDMA, or multiuser MIMO.

Moreover, when the content control information received from the timing controller 611 is indicative of a relative time, the data transmitter 714 may calculate, for example, the reference timer value, by adding the timer value in the synchronization timer 712 to the relative time. Then, the data transmitter 714 complements the content control information with the calculated reproduction start time and transmits the information to the one or more video clients and also outputs the information to the timing signal generator 713.

The time synchronizer 711 and the data transmitter 714 are expressed as separate elements in FIG. 12 but may both be implemented using the communicator 703.

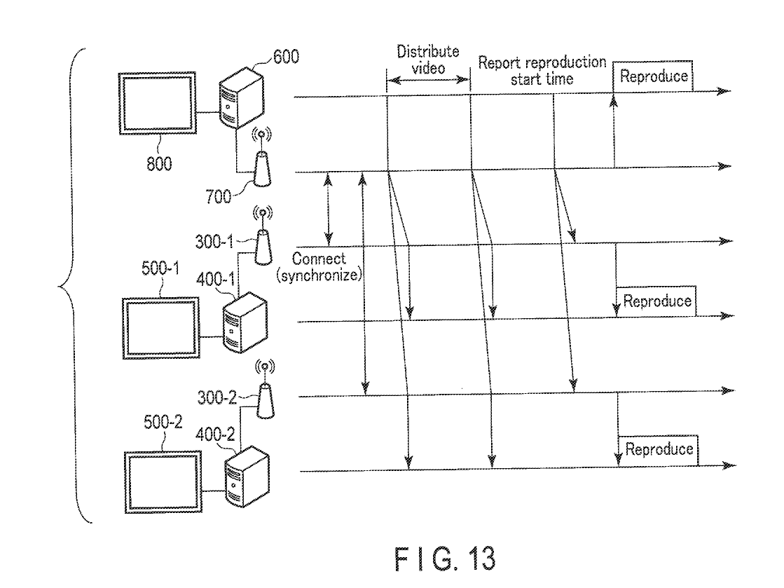

The video synchronization display system according to the present embodiment can operate as illustrated in FIG. 13. In the example in FIG. 13, a communication apparatus 300-1 and a communication apparatus 300-2 connect to the communication apparatus 700, and the synchronization timers in the communication apparatuses 300-1 and 300-2 accurately synchronize with each other. Then, the content server distributes video content to the two content clients and notifies the content clients of the reproduction start time (content control information). A client apparatus 400-1, a client apparatus 400-2, and the server apparatus 600 can substantially simultaneously display the video content on a display apparatus 500-1, a display apparatus 500-2, and the display apparatus 800 in accordance with a timing signal generated based on the reproduction start time and the timer values in the synchronization timers inside the communication apparatus 300-1, the communication apparatus 300-2, and the communication apparatus 700.

As described above, the video synchronization display system according to the second embodiment establishes connections among the communication apparatuses included in the video server and the one or more video clients to accurately synchronize the timers inside the communication apparatuses with one another, as is the case with the first embodiment. The video synchronization display system then performs various types of control on video content based on the timer values in the timers. Thus, the video synchronization display system allows the one or more video clients to accurately synchronously display the video content.

Moreover, in the video synchronization display system according to the present embodiment, the video server also displays video content, thus reducing the number of video clients needed for a predetermined number of display apparatuses by one. Hence, the video synchronization display system enables a reduction in hardware costs. In the video synchronization display system, the hardware in the video server is approximately the same as the hardware in the video client. Consequently, the video synchronization display system may be designed such that the functions of the video server and the video client can be changed using, for example, a hardware switch or a software switch.

### Third Embodiment

In the above-described first embodiment and second embodiment, the technique for synchronously controlling video content has been described. However, these embodiments are applicable not only to the synchronous control of video content but also to the synchronous control of various contents.

The content referred to in the present embodiment means data for which the control timing needs to be synchronized at a plurality of locations. The synchronization of the control timing is not necessarily limited to the coincidence at a plurality of locations, but a time difference may be intentionally made among the plurality of locations.

For example, audio contents may be handled according to the present embodiment. Specifically, the present embodiment is applicable to a multispeaker system. In the multispeaker system, speakers disposed at a plurality of locations can accurately synchronously output the same audio content. Alternatively, the present embodiment is applicable to a system that provides out-of-head sound localization. In this system, the speakers disposed at the plurality of locations can output audio content with predetermined time differences to provide a listener with out-of-head sound localization.

Moreover, the content may be a machine control pattern. For example, the content may be a control pattern for a plurality of lighting devices (for example, stage lights, LEDs (Light Emitting Diodes), and luminaries), a plurality of domestic devices (for example, home electric appliances and furniture), a control pattern for a plurality of industrial machines in a production line, a control pattern for a coordinate operation of a plurality of robots such as a dance or musical performance, a control pattern for a plurality of sensors, or a control pattern for a firing apparatus for a plurality of fireworks or firecrackers in a firework festival. Alternatively, the content may be a control pattern for a plurality of staging apparatuses for sounds, light, and videos used in a parade held in an amusement park.

The content is not limited to the above-described examples and may be a control pattern for, for example, light, sound, electricity, magnetism, or pressure. Moreover, the present embodiment is applicable not only to an entertainment field or an industrial field but also to a healthcare field, an energy field, a traffic field, or the like.

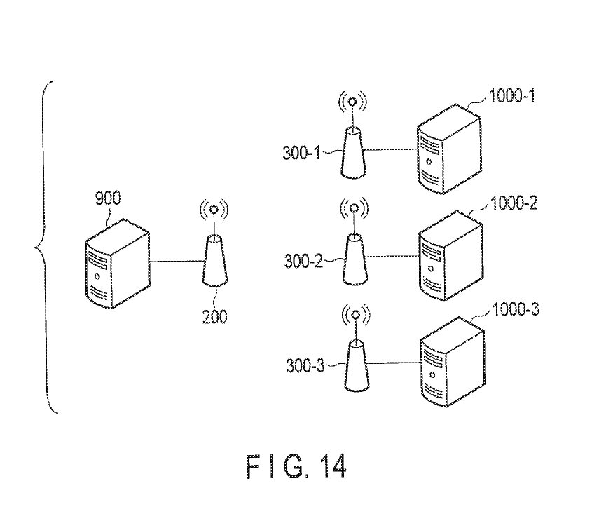

A content synchronization output system according to the third second embodiment includes a content server and a plurality of content clients. The content server includes a server apparatus 900 and a communication apparatus 200. The content client includes a communication apparatus 300 and a client apparatus 1000. The content synchronization output system according to the present embodiment is illustrated in FIG. 14. The content synchronization output system in FIG. 14 includes a content server and three content clients. The content synchronization output system may handle a plurality of types of contents.

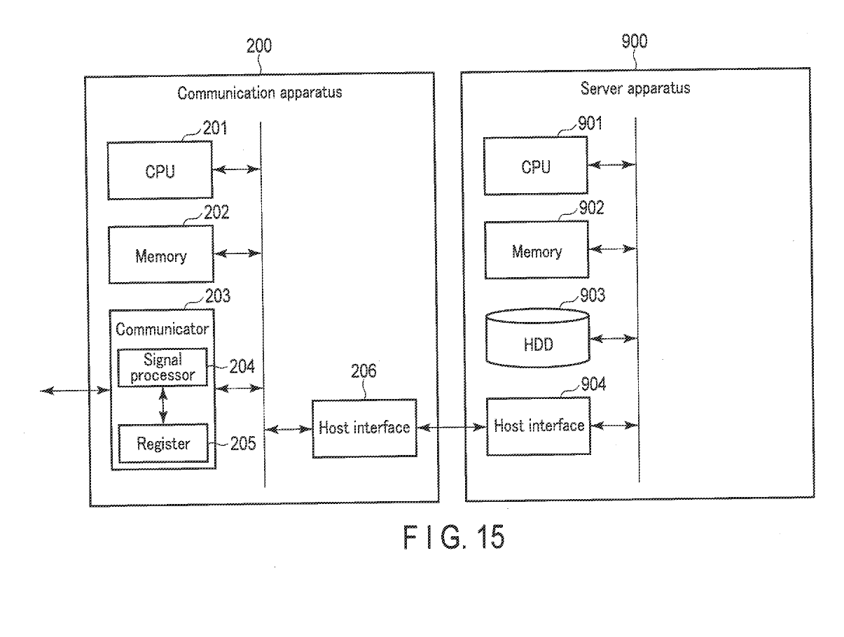

FIG. 15 depicts an example of hardware configurations of the server apparatus 900. The server apparatus 900 in FIG. 15 includes a CPU 901, a memory 902, an HDD 903, and a host interface 904. The pieces of hardware included in the server apparatus 900 in FIG. 15 are connected together via a bus.

The CPU 901, for example, executes programs saved in the memory 902 to control the hardware included in the server apparatus 900. The CPU 901 may be replaced with various processors, for example, an MPU, an MeP, a microcontroller, an FPGA, and a GPU.

For example, programs executed by the CPU 901 and data used by the programs are temporarily saved in the memory 902. The memory 902 may be a volatile memory, for example, an SRAM or a DRAM, or a nonvolatile memory.

For example, content to be distributed to the content clients is saved in the HDD 903. The HDD 903 may be replaced, for example, with an SSD or with a flash memory connected to the bus via host interface not depicted in the drawings.

The host interface 904 transmits signals (signals carrying, for example, content or content control information) between the server apparatus 900 and the communication apparatus 200. The host interface 904 may be a general-purpose interface, for example, a USB, an SDIO, a UART, an I2C, an SPI, or a PCIe, or a dedicated interface.

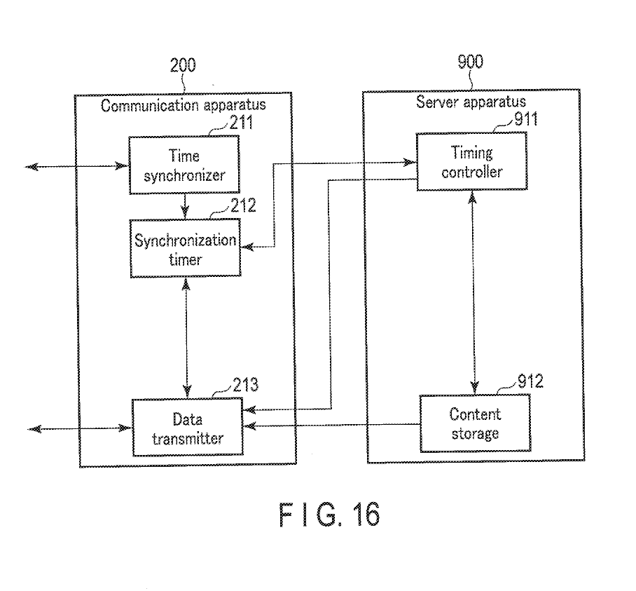

FIG. 16 depicts an example of a functional configuration of the server apparatus 900. The server apparatus 900 includes a timing controller 911 and a content storage 912.

The timing controller 911 determines a timing when predetermined control is performed on content. The timing controller 911 generates content control information explicitly or implicitly indicative of the determined timing, and outputs the content control information to the data transmitter 213. The content control information may be, for example, information explicitly or implicitly indicative of the time when output of content to be synchronously output is started.

The timing controller 911 may reference a timer value in the synchronization timer 212 inside the communication apparatus 200 to determine the above-described timing based on the timer value. Specifically, the timing controller 911 may determine a particular absolute time later than the timer value to be the output start time.

Furthermore, the timing controller 911 may determine a relative time needed to calculate the output start time. In this case, a first technique and a second technique may be adopted; in the first technique, the content server calculates the output start time, and in the second technique, each content client calculates the output start time.

According to the first technique, the timing controller 911 outputs content control information indicative of a relative time to the data transmitter 213. The data transmitter 213 calculates the output start time by adding the timer value in the synchronization timer 212 to the relative time indicated by the content control information. The data transmitter 213 complements the content control information with the calculated output start time and transmits the information to the plurality of content clients.

According to the second technique, the data transmitter 213 transmits the content control information indicative of the relative time determined by the timing controller 911, to the plurality of content clients. Each of the content clients calculates the output start time by adding the relative time indicated by the content control information to the timer value in the synchronization timer inside the content client. However, compared to the first technique, the second technique may involve a degraded synchronization accuracy due to, for example, a channel transmission delay or a reception process delay.

Content to be distributed to the content client is saved in the content storage 912. The content saved in the content storage 912 is read as needed and transferred to the data transmitter 213. The content storage 912 is not necessary given that the content to be synchronously output is already saved in all the content clients. However, when there are a plurality of contents that can be selected, identifier information that allows the content to be identified may be transmitted in order to uniquely identify the content to be synchronously output.

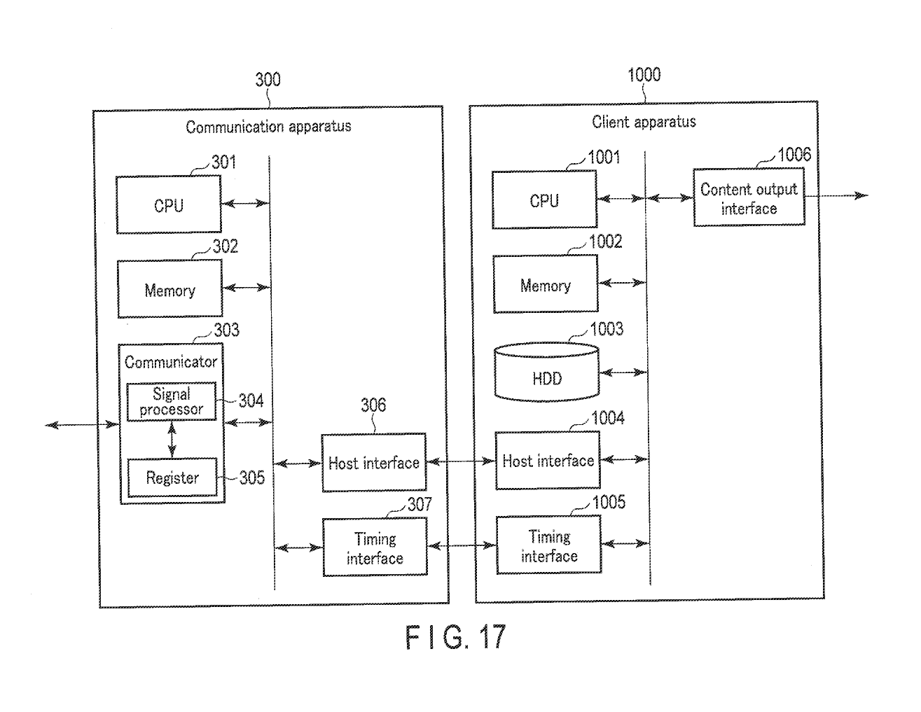

FIG. 17 depicts an example of a hardware configuration of the client apparatus 1000. The client apparatus 1000 in FIG. 17 includes a CPU 1001, a memory 1002, an HDD 1003, a host interface 1004, a timing interface 1005, and a content output interface 1006. The pieces of hardware included in the client apparatus 1000 in FIG. 17 are connected together via a bus.

The CPU 1001, for example, executes programs saved in the memory 1002 to control the hardware included in the client apparatus 1000. The CPU 1001 may be replaced with various processors, for example, an MPU, an MeP, a microcontroller, an FPGA, and a GPU.

For example, programs executed by the CPU 1001 and data used by the programs are temporarily saved in the memory 1002. The memory 1002 may be a volatile memory, for example, an SRAM or a DRAM, or a nonvolatile memory.

For example, content distributed by the video server is saved in the HDD 1003. The HDD 1003 may be replaced with, for example, an SSD or with a flash memory connected to the bus via a host interface not depicted in the drawings.

The host interface 1004 transmits signals other than those which are related to the timing (signals carrying, for example, content) between the client apparatus 1000 and the communication apparatus 300. The host interface 1004 may be a general-purpose interface, for example, a USB, an SDIO, a UART, an I2C, an SPI, or a PCIe, or a dedicated interface.

The timing interface 1005 receives signals related to the timing from the communication apparatus 300. The timing interface 1005 may be a digital general-purpose interface, for example, a USB, an SDIO, a UART, an I2C, an SPI, or a PCIe, or an analog general-purpose interface, for example, a PIO or a GPIO. A transmission delay in the signal related to the timing affects the synchronization accuracy for output content. Thus, the timing interface 1005 preferably has a short transmission delay and an insignificant fluctuation in transmission delay.

The content output interface 1006 transmits signals (for example, a signal depending on the type of the content, such as an audio signal and a machine control signal) between the client apparatus 1000 and a content output apparatus not depicted in the drawings. The details of the content output interface 1006 and the content output apparatus depend on the type of content handled by the content client in FIG. 17.

For example, when audio content is handled, a speaker corresponds to the content output apparatus, and an audio interface for the speaker corresponds to the content output interface 1006. When a control pattern for lighting devices is to be handled, the content output interface 1006 may be analog pins, for example, PIOs. When a control pattern for a motor is to be handled, the content output interface 1006 may be a PWM (Pulse Width Modulation) interface.

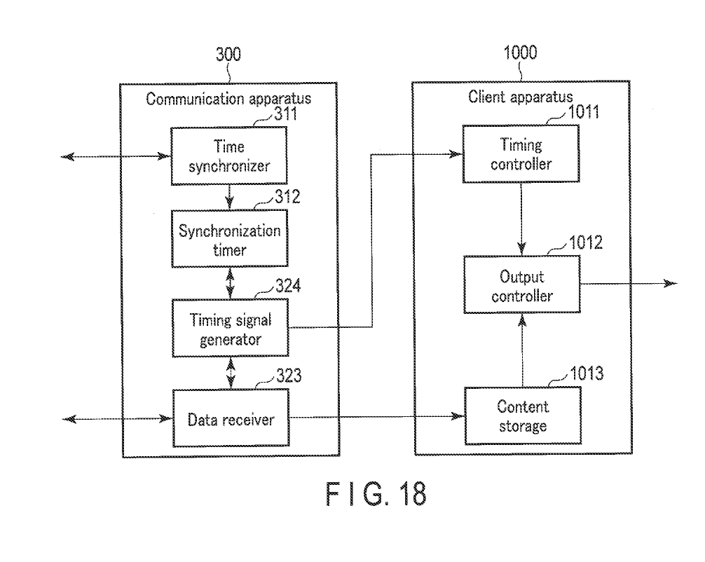

FIG. 18 depicts an example of a functional configuration of the client apparatus 1000. The client apparatus 1000 includes a timing controller 1011, an output controller 1012, and a content storage 1013.

The timing controller 1011 receives a signal carrying the current timer value from the synchronization timer 312, and also receives a signal carrying content control information from the data receiver 313. Based on the current timer value and the content control information, the timing controller 1011 generates a timing signal reporting arrival of a control timing (for example, the output start time) for the content stored in the content storage 1013. The timing controller 1011 outputs the timing signal to the output controller 1012.

The output controller 1012 receives the timing signal from the timing controller 1011 and reads the content from the content storage 1013. The output controller 1012 performs control such as output and stoppage of the content on a timely basis in accordance with the timing signal. The output controller 1012 may utilize a timing signal based on an output end time as well as the output start time. Such a timing signal is effective in view of fail safety. Furthermore, the output controller 1012 may utilize a periodic timing signal in order to stably maintain synchronization for a long period.

The content storage 1013 receives a signal carrying content from the data receiver 313 via the host interface 1004. The received video content is stored in the video storage 1013. The content stored in the video storage 1013 may be read by the output controller 1012 as needed.

As described above, the content synchronization output system according to the third embodiment corresponds to a system resulting from expansion of the above-described first embodiment and second embodiment to various contents instead of limitation to video contents. Thus, this system allows effects identical or similar to the effects of the first embodiment and the second embodiment to be exerted when content other than video content is to be synchronously output.

The server apparatus and client apparatus described in each embodiment may be implemented by using a general-purpose computer as basic hardware. For example, the timing controller, the reproduction controller, and the output controller may be implemented by allowing the processor mounted in the computer to execute the relevant programs. Furthermore, the video storage and the content storage may be implemented utilizing various recording media (for example, a memory, an HDD, a CD-R, a CD-RW, a DVD-RAM, and a DVD-R) incorporated in or externally attached to the computer, as needed.

The programs may be preinstalled in the computer or stored in a computer readable recording medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a timer that updates a first timer value by counting up in synchronization with a clock signal;
a synchronization processor that executes a time synchronization process in order to synchronize the first timer value with a second timer value inside each of other communication apparatuses belonging to a common network;
a signal generator that generates a timing signal reporting arrival of a timing when content is to be controlled, based on the first timer value and content control information indicative of the timing when the content is to be controlled.

2. The apparatus according to claim 1, further comprising a receiver that accesses a channel based on the first timer value to receive the content control information from one of the other communication apparatuses.

3. The apparatus according to claim 2, wherein the synchronization processor receives timer control information indicative of the second timer value from one of the other communication apparatuses to overwrite the first timer value with the second timer value.

4. The apparatus according to claim 2, wherein the synchronization processor transmits timer control information indicative of the first timer value to the other communication apparatuses.

5. The apparatus according to claim 2, wherein the synchronization processor transmits timer control information indicative of the first timer value to the other communication apparatuses, receives timer control information indicative of the second timer value from each of the other communication apparatuses, and overwrites the first timer value with the second timer value when the second timer value is greater than the first timer value.

6. The apparatus according to claim 2, wherein the timing signal has a period based on characteristic information on the content.

7. The apparatus according to claim 2, wherein, when a processing load on the receiver is equal to or higher than a threshold, the signal generator schedules an execution timing for a process of generating the timing signal in such a manner that the process is executed earlier than when the processing load is lower than the threshold.

8. The apparatus according to claim 1, further comprising a transmitter that accesses a channel based on the first timer value to transmit the content control information to the other communication apparatuses.

9. The apparatus according to claim 8, wherein the synchronization processor transmits timer control information indicative of the first timer value to the other communication apparatuses.

10. The apparatus according to claim 8, wherein the synchronization processor receives timer control information indicative of the second timer value from one of the other communication apparatuses to overwrite the first timer value with the second timer value.

11. The apparatus according to claim 8, wherein the synchronization processor transmits timer control information indicative of the first timer value to the other communication apparatuses, receives timer control information indicative of the second timer value from each of the other communication apparatuses, and overwrites the first timer value with the second timer value when the second timer value is greater than the first timer value.

12. The apparatus according to claim 8, wherein the timing signal has a period based on characteristic information on the content.

13. The apparatus according to claim 8, wherein, when a processing load on the transmitter is equal to or higher than a threshold, the signal generator schedules an execution timing for a process of generating the timing signal in such a manner that the process is executed earlier than when the processing load is lower than the threshold.

14. A content client comprising:
the communication apparatus according to claim 1; and
a client apparatus that comprises a content controller that controls content in accordance with the timing signal.

15. A content server comprising a server apparatus and a communication apparatus, wherein
the server apparatus comprises a timing controller that generates content control information indicative of a timing when content is to be controlled, and
the communication apparatus comprises:
a timer that updates a first timer value by counting up in synchronization with a clock signal;
a synchronization processor that executes a time synchronization process in order to synchronize the first timer value with a second timer value inside each of other communication apparatuses belonging to a common network; and
a transmitter that accesses a channel based on the first timer value to transmit the content control information to the other communication apparatuses.

16. The server according to claim 15, wherein the synchronization processor transmits timer control information indicative of the first timer value to the other communication apparatuses.

17. The server according to claim 15, wherein the synchronization processor receives timer control information indicative of the second timer value from one of the other communication apparatuses to overwrite the first timer value with the second timer value.

18. The server according to claim 15, wherein the synchronization processor transmits timer control information indicative of the first timer value to the other communication apparatuses, receives timer control information indicative of the second timer value from each of the other communication apparatuses, and overwrites the first timer value with the second timer value when the second timer value is greater than the first timer value.

19. The server according to claim 15, wherein
the communication apparatus further comprises a signal generator that generates a timing signal reporting arrival of a timing when the content is to be controlled, based on the content control information and the first timer value, and
the server apparatus further comprises a content controller that controls the content in accordance with the timing signal.
